(19) United States
(12) Patent Application Publication
(10) Pub. No.: US 2025/0365124 A1
(43) Pub. Date: Nov. 27, 2025

(54) FRONT-END RADIO FREQUENCY ARCHITECTURE WITH IMPROVED TRANSMIT LEAKAGE

(71) Applicant: Skyworks Solutions, Inc., Irvine, CA (US)

(72) Inventors: Jiunn-Sheng Guo, Eastvale, CA (US); Tianming Chen, Newbury Park, CA (US); Toru Jibu, Kobe-Shi (JP)

(21) Appl. No.: 19/204,372

(22) Filed: May 9, 2025

Related U.S. Application Data
(60) Provisional application No. 63/645,730, filed on May 10, 2024.

(51) Int. Cl. H04L 5/14

(52) U.S. Cl. CPC H04L 5/1461

(57) ABSTRACT

A radio frequency module includes a transmit amplifier configured to amplify a transmit signal a receive amplifier configured to amplify a receive signal. The radio frequency module further includes at least one duplexer configured for operation in a frequency division duplex band having a transmit band and a receive band and further configured to filter the transmit signal to pass the transmit band and to filter the receive signal to pass the receive band. The at least one duplexer is coupled to the transmit amplifier via a first node and to the receive amplifier via a second node. A series acoustic resonator directly can be connected to the second node to increase a receive impedance of the at least one duplexer across the transmit band of the at least one duplexer.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

Embodiments of the invention relate to electronic systems, and in particular, to front-end system for use in radio frequency (RF) electronics.

### Description of the Related Technology

Front end systems aid in conditioning signals transmitted to and/or received from antennas of wireless devices. For example, front end systems include power amplifiers (PAs), low noise amplifiers (LNAs), filters, switches, and duplexers.

A front end system can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

### SUMMARY OF CERTAIN EMBODIMENTS

In some aspects, the techniques described herein relate to a radio frequency module including: a power amplifier disposed along a transmit signal path for a transmit signal and configured to amplify the transmit signal for transmission; a low-noise amplifier disposed along a receive signal path for a receive signal and configured to amplify the receive signal; and at least one duplexer configured to filter the transmit signal or the receive signal, the at least one duplexer coupled to the power amplifier via a first node and to the low-noise amplifier via a second node to include sections of both the transmit signal path and the receive signal path therein, the at least one duplexer including a series resonator directly connected to the second node along the receive signal path such as to increase an impedance of the at least one duplexer along the receive signal path when transmitting the transmit signal.

In some aspects, the techniques described herein relate to a radio frequency module wherein the radio frequency module is a front-end module.

In some aspects, the techniques described herein relate to a radio frequency module wherein a coefficient Γ of the impedance along the receive signal path is configured to be larger than 0.9.

In some aspects, the techniques described herein relate to a radio frequency module wherein a transmit band for transmitting the transmit signal is below an receive band for receiving the receive signal.

In some aspects, the techniques described herein relate to a radio frequency module further including a matching inductor disposed on the low-noise amplifier to lower a gain of the low-noise amplifier at a transmit band for transmitting the transmit signal.

In some aspects, the techniques described herein relate to a radio frequency module wherein the at least one duplexer is configured to filter both the transmit signal and the receive signal.

In some aspects, the techniques described herein relate to a radio frequency module wherein the low-noise amplifier is configured to have lower transconductance for receiving the receive signal with the increased impedance of the at least one duplexer.

In some aspects, the techniques described herein relate to a mobile device including: a transceiver configured to generate a transmission signal and to process a receive signal; and a radio frequency module including a power amplifier disposed along a transmit signal path for the transmit signal and configured to amplify the transmit signal for transmission; a low-noise amplifier disposed along an receive signal path for the receive signal and configured to amplify the receive signal; and at least one duplexer configured to filter the transmit signal or the receive signal within respective frequency ranges, the at least one duplexer coupled to the power amplifier via a first node and to the low-noise amplifier via a second node to include sections of both the transmit signal path and the receive signal path therein, the at least one duplexer including a series resonator directly connected to the second node along the receive signal path such as to increase an impedance of the at least one duplexer along the receive signal path when transmitting the transmit signal.

In some aspects, the techniques described herein relate to a mobile device wherein the radio frequency module is a front-end module.

In some aspects, the techniques described herein relate to a mobile device wherein a coefficient Γ of the impedance along the receive signal path is configured to be larger than 0.9.

In some aspects, the techniques described herein relate to a mobile device wherein a transmit band for transmitting the transmit signal is below an receive band for receiving the receive signal.

In some aspects, the techniques described herein relate to a mobile device further including a matching inductor disposed on the low-noise amplifier to lower a gain of the low-noise amplifier a transmit band for transmitting the transmit signal.

In some aspects, the techniques described herein relate to a mobile device wherein the low-noise amplifier is configured to have lower transconductance for receiving the receive signal with the increased impedance of the at least one duplexer.

In some aspects, the techniques described herein relate to a mobile device wherein the at least one duplexer is configured to filter both the transmit signal and the receive signal.

In some aspects, the techniques described herein relate to an antenna switch module arrangement including: an antenna switch module including at least two transmit/receive terminals and an antenna terminal; and at least two duplexers, each respective duplexer of the at least two duplexers coupled to a corresponding one of the at least two transmit/receive terminals, each configured to filter a transmit signal or a receive signal, each configured to couple to a power amplifier via a first node and to a low-noise amplifier via a second node to include sections of both a transmit signal path and a receive signal path therein, each of the at least two duplexers including a series resonator directly connected to the second node along the receive signal path such as to increase an impedance of the duplexer along the receive signal path when transmitting the transmit signal.

In some aspects, the techniques described herein relate to an antenna switch module arrangement wherein, for each respective duplexer of the at least two duplexers, a coefficient Γ of the impedance along the receive signal path corresponding to the respective duplexer is configured to be larger than 0.9.

In some aspects, the techniques described herein relate to an antenna switch module arrangement wherein, for each respective duplexer of the at least two duplexers, a transmit band for transmitting the transmit signal corresponding to the respective duplexer is below an receive band for receiving the receive signal corresponding to the respective duplexer.

In some aspects, the techniques described herein relate to an antenna switch module arrangement further including, for each respective duplexer of the at least two duplexers, a matching inductor disposed on the low-noise amplifier corresponding to the respective duplexer to lower a gain of the low-noise amplifier at a transmit band for transmitting the transmit signal corresponding to the respective duplexer.

In some aspects, the techniques described herein relate to an antenna switch module arrangement wherein, for each respective duplexer of the at least two duplexers, the low-noise amplifier corresponding to the respective duplexer is configured to have lower transconductance for receiving the receive signal corresponding to the respective duplexer with the increased impedance of the respective duplexer.

In some aspects, the techniques described herein relate to an antenna switch module arrangement wherein each respective duplexer of the at least two duplexers is configured to filter both the transmit signal and the receive signal corresponding to the respective duplexer.

### BRIEF DESCRIPTION OF THE DRAWINGS

FIG. 1 is a schematic diagram of one embodiment of a mobile device.

FIG. 2 is a block diagram of a front-end module.

FIG. 3 is a block diagram of an antenna switching module arrangement.

FIG. 4 illustrates a wireless device having a primary antenna and a diversity antenna.

FIG. 5 illustrates a wireless device that incorporates some or all of the configurations described herein.

FIG. 6 illustrates a change of TX leakage when a mobile device is turned on.

FIG. 7 illustrates a schematic diagram of an example of a radio frequency module according to an embodiment of the present disclosure.

FIG. 8 illustrates an example of RX contours on a Smith Chart for a duplexer in a radio frequency module.

FIG. 9 illustrates another example of RX contours on a Smith Chart for a duplexer in a radio frequency module.

FIG. 10 illustrates an example of a duplexer including a series resonator.

FIG. 11 illustrates an example of RX contours on a Smith Chart for the radio frequency module.

FIG. 12 illustrates an example of the frequency response of the duplexer depending on the value of inductance of the matching inductor.

FIGS. 13-1 and 13-2 illustrate examples of RX contours on a Smith Chart for embodiments of a duplexer depending on the resistance of the LNA.

FIG. 14A is a schematic diagram of one embodiment of a packaged module.

FIG. 14B is a schematic diagram of a cross-section of the packaged module of FIG. 14A taken along the lines 14B-14B.

FIG. 15 is a schematic diagram of one embodiment of a phone board.

### DETAILED DESCRIPTION OF EMBODIMENTS

The following detailed description of certain embodiments presents various descriptions of specific embodiments. However, the innovations described herein can be embodied in a multitude of different ways, for example, as defined and covered by the claims. In this description, reference is made to the drawings where like reference numerals can indicate identical or functionally similar elements. It will be understood that elements illustrated in the figures are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

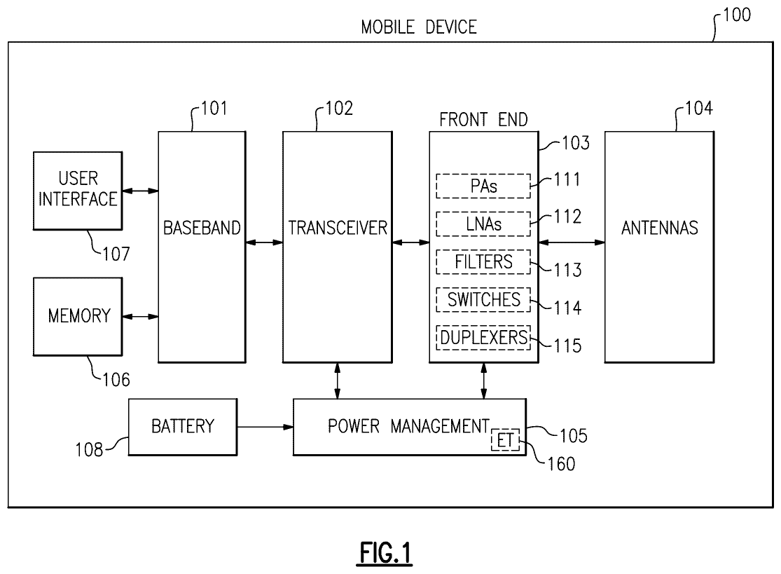

FIG. 1 is a schematic diagram of one example of a mobile device 100. The mobile device 100 includes a baseband system 101, a transceiver 102, a front end system 103, antennas 104, a power management system 105, a memory 106, a user interface 107, and a battery 108.

The mobile device 100 can be used communicate using a wide variety of communications technologies, including, but not limited to, 2G, 3G, 4G (including LTE, LTE-Advanced, and LTE-Advanced Pro), 5G, WLAN (for instance, Wi-Fi), WPAN (for instance, Bluetooth and ZigBee), WMAN (for instance, WiMax), and/or GPS technologies.

The transceiver 102 generates RF signals for transmission and processes incoming RF signals received from the antennas 104. It will be understood that various functionalities associated with the transmission and receiving of RF signals can be achieved by one or more components that are collectively represented in FIG. 1 as the transceiver 102. In one example, separate components (for instance, separate circuits or dies) can be provided for handling certain types of RF signals.

The front end system 103 aids in conditioning signals transmitted to and/or received from the antennas 104. In the illustrated embodiment, the front end system 103 includes power amplifiers (PAs) 111, low noise amplifiers (LNAs) 112, filters 113, switches 114, and duplexers 115. However, other implementations are possible.

For example, the front end system 103 can provide a number of functionalities, including, but not limited to, amplifying signals for transmission, amplifying received signals, filtering signals, switching between different bands, switching between different power modes, switching between transmission and receiving modes, duplexing of signals, multiplexing of signals (for instance, diplexing or triplexing), or some combination thereof.

In certain implementations, the mobile device 100 supports carrier aggregation, thereby providing flexibility to increase peak data rates. Carrier aggregation can be used for both Frequency Division Duplexing (FDD) and Time Division Duplexing (TDD), and may be used to aggregate a plurality of carriers or channels. Carrier aggregation includes contiguous aggregation, in which contiguous carriers within the same operating frequency band are aggregated. Carrier aggregation can also be non-contiguous, and can include carriers separated in frequency within a common band and/or in different bands.

The antennas 104 can include antennas used for a wide variety of types of communications. For example, the antennas 104 can include antennas associated transmitting and/or receiving signals associated with a wide variety of frequencies and communications standards.

In certain implementations, the antennas 104 support MIMO communications and/or switched diversity communications. For example, MIMO communications use multiple antennas for communicating multiple data streams over a single radio frequency channel. MIMO communications benefit from higher signal to noise ratio, improved coding, and/or reduced signal interference due to spatial multiplexing differences of the radio environment. Switched diversity refers to communications in which a particular antenna is selected for operation at a particular time. For example, a switch can be used to select a particular antenna from a group of antennas based on a variety of factors, such as an observed bit error rate and/or a signal strength indicator.

The mobile device 100 can operate with beamforming in certain implementations. For example, the front end system 103 can include phase shifters having variable phase controlled by the transceiver 102. Additionally, the phase shifters are controlled to provide beam formation and directivity for transmission and/or reception of signals using the antennas 104. For example, in the context of signal transmission, the phases of the transmit signals provided to the antennas 104 are controlled such that radiated signals from the antennas 104 combine using constructive and destructive interference to generate an aggregate transmit signal exhibiting beam-like qualities with more signal strength propagating in a given direction. In the context of signal reception, the phases are controlled such that more signal energy is received when the signal is arriving to the antennas 104 from a particular direction. In certain implementations, the antennas 104 include one or more arrays of antenna elements to enhance beamforming.

The baseband system 101 is coupled to the user interface 107 to facilitate processing of various user input and output (I/O), such as voice and data. The baseband system 101 provides the transceiver 102 with digital representations of transmit signals, which the transceiver 102 processes to generate RF signals for transmission. The baseband system 101 also processes digital representations of received signals provided by the transceiver 102. As shown in FIG. 1, the baseband system 101 is coupled to the memory 106 of facilitate operation of the mobile device 100.

The memory 106 can be used for a wide variety of purposes, such as storing data and/or instructions to facilitate the operation of the mobile device 100 and/or to provide storage of user information.

The power management system 105 provides a number of power management functions of the mobile device 100. The power management system 105 of FIG. 1 includes an envelope tracker 160. As shown in FIG. 1, the power management system 105 receives a battery voltage form the battery 1008. The battery 108 can be any suitable battery for use in the mobile device 100, including, for example, a lithium-ion battery.

The mobile device 100 of FIG. 1 illustrates one example of an RF communication system that can include low noise amplifier(s) implemented in accordance with one or more features of the present disclosure. However, the teachings herein are applicable to RF communication systems implemented in a wide variety of ways.

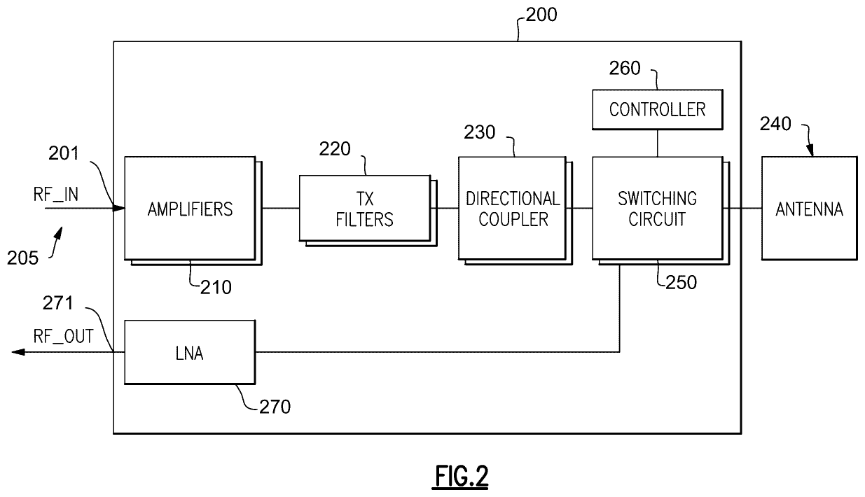

FIG. 2 is a block diagram illustrating an example of a typical arrangement of a radio-frequency (RF) “front-end” sub-system or module (FEM) 200 as may be used in a communications device, such as a mobile phone, for example, to transmit and receive RF signals. The FEM 200 shown in FIG. 2 includes a transmit path (TX) configured to provide signals to an antenna for transmission and a receive path (RX) to receive signals from the antenna. In the transmit path (TX), a power-amplifier module 210 provides gain to an RF signal 205 received by the FEM 200 via an input port 201, producing an amplified RF signal. The power amplifier module 210 can include one or more power amplifiers (PAs), or “amplifiers.”

The FEM 200 can further include a filtering sub-subsystem or module 220, which can include one or more filters. In some examples, a directional coupler 230 can be used to extract a portion of the power from the RF signal traveling between the power-amplifier module 210 and an antenna 240 connected to the FEM 200. The antenna 240 can transmit the RF signal and can also receive RF signals. A switching circuit 250, also referred to as an antenna switch module (ASM), can be used to switch between a transmitting mode and receiving mode of the FEM 200, for example, or between different transmit or receive frequency bands. In certain examples, the switching circuit 250 can be operated under the control of a controller 260.

The FEM 200 can also include a receive path (RX) configured to process signals received by the antenna 240 and provide the received signals to a signal processor (e.g., a transceiver) via an output port 271. The receive path (RX) can include one or more low-noise amplifiers (LNA) 270 to amplify the signals received from the antenna 240. Although not shown, the receive path (RX) can also include one or more filters for filtering the received signals.

As described above, antenna switching modules (e.g., switching circuit 250) can be used in front end module (FEM) products, such as radio transceivers, wireless handsets, and the like. In one example, the ASM is configured to connect the antenna to either the transmit path (TX) or the receive path (RX) depending on the mode of operation. In some examples, the ASM may be coupled to multiple duplexers for multi-band applications.

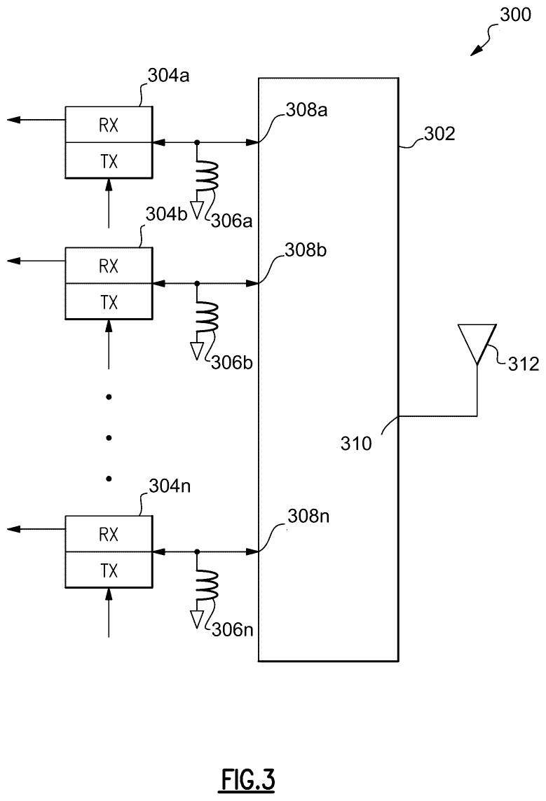

FIG. 3 is a schematic diagram of an ASM arrangement 300. In one example, the ASM arrangement 300 may be included in a FEM (e.g., the FEM 200 of FIG. 2). The ASM arrangement 300 includes an ASM 302, a plurality of duplexers 204, and a plurality of shunt inductors 306. As shown, the ASM 302 includes a plurality of transmit/receive (T/R) terminals 308 coupled to the plurality of duplexers 304. For example, the first input 308 a is coupled to the first duplexer 304a, the second input 308b is coupled to the second duplexer 304b, and so on. In some examples, the ASM 302 includes an antenna terminal 310 coupled to an antenna 312. In this context, the term “terminal” may be used interchangeably with “port” or “pin”.

In one example, each of the plurality of duplexers 304 is coupled to a pair of receive (RX) and transmit (TX) paths. Each duplexer of the plurality of duplexers 304 may include switching, coupling, and/or filtering circuitry configured to direct radio frequency (RF) signals to/from the respective receive (RX) and transmit (TX) paths. In some examples, the ASM 302 can be operated or controlled in different modes of operation to connect each of the plurality of duplexers 304 to the antenna 312 (via the antenna terminal 310). For example, in a first mode of operation, the ASM 302 can be controlled to connect the first duplexer 304a to the antenna 312 by coupling the first T/R terminal 308a to the antenna terminal 310. As such, during the first mode of operation, RF signals received by the antenna 312 are provided to the receive (RX) path coupled to the first duplexer 304a. Likewise, during the first mode of operation, RF signals provided by the transmit (TX) path coupled to the first duplexer 304a can be transmitted by the antenna 312. Similarly, in a second mode of operation, the ASM 302 can be controlled to connect the second duplexer 304b to the antenna 312 by coupling the second T/R terminal 308b to the antenna terminal 310, and so on.

In some examples, each duplexer of the plurality of duplexers 304 corresponds to a specific frequency or frequency band. For example, the first duplexer 304a and the receive (RX) and transmit (TX) paths coupled to the first duplexer 304a may correspond to a first frequency or frequency band. As such, the ASM 302 can be controlled to operate in the first mode of operation when transmitting/receiving RF signals corresponding to the first frequency (or frequency band). Likewise, the second duplexer 304b and the receive (RX) and transmit (TX) paths coupled to the second duplexer 304b may correspond to a second frequency or frequency band and the ASM 302 can be controlled to operate in the second mode of operation when transmitting/receiving RF signals corresponding to the second frequency (or frequency band), and so on.

In order to provide optimal performance (e.g., low loss) at each frequency (or frequency band), the resonant frequency of each duplexer (and the respective RX, TX paths) may be tuned or adjusted via impedance matching. In one example, the plurality of shunt inductors 306 are coupled between the plurality of duplexers 304 and the plurality of inputs 308 to provide an impedance match during each mode of operation. For example, the first shunt inductor 306a is configured to adjust the impedance of the first duplexer 304a and the receive (RX) and transmit (TX) paths coupled to the first duplexer 304a to provide a resonant frequency at the first frequency (or frequency band) during the first mode of operation. Likewise, the second shunt inductor 306b is configured to adjust the impedance of the second duplexer 304b and the receive (RX) and transmit (TX) paths coupled to the second duplexer 304b to provide a resonant frequency at the second frequency (or band) during the second mode of operation, and so on.

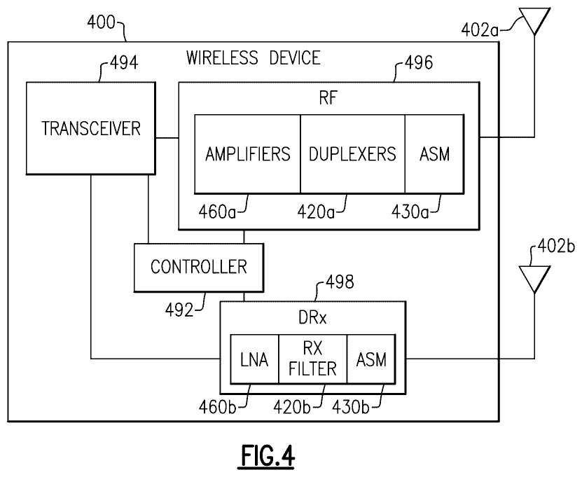

FIG. 4 illustrates a wireless device 400 having a primary antenna 402a and a diversity antenna 402b. The wireless device 400 includes an RF module 496 and a transceiver 494 that may be controlled by a controller 492. The transceiver 494 is configured to convert between analog signals (e.g., radio-frequency (RF) signals) and digital data signals. To that end, the transceiver 494 may include a digital-to-analog converter, an analog-to-digital converter, a local oscillator for modulating or demodulating a baseband analog signal to or from a carrier frequency, a baseband processor that converts between digital samples and data bits (e.g., voice or other types of data), or other components.

The RF module 496 is coupled between the primary antenna 402a and the transceiver 494. Because the RF module 496 may be physically close to the primary antenna 402a to reduce attenuation due to cable loss, the RF module 496 may be referred to as a front-end module (FEM). The RF module 496 may perform processing on an analog signal received from the primary antenna 402a for the transceiver 494 or received from the transceiver 494 for transmission via the primary antenna 402a. To that end, the RF module 496 includes an antenna switch module (ASM) 430a, one or more duplexers 420a, one or more amplifiers 460a (including power amplifiers (PAs) and low noise amplifiers (LNAs)) and may also include amplifier switches, band select switches, attenuators, matching circuits, multiplexers, and other components. The ASM 430a may be connected to a plurality of duplexers 420a to enable operation across a plurality of frequency bands. A signal for transmission can be sent from the transceiver 494 through the RF module 496, being amplified by an amplifier 460a (e.g., a PA), filtered by a duplexer 420a, and coupled to the primary antenna 402a via the ASM 430a. A signal received at the antenna 402a can be sent through the RF module 496, being connected to a duplexer 420a via the ASM 430a, being filtered by the duplexer 420a, and being amplified by an amplifier 460a (e.g., a LNA) before being sent to the transceiver 494.

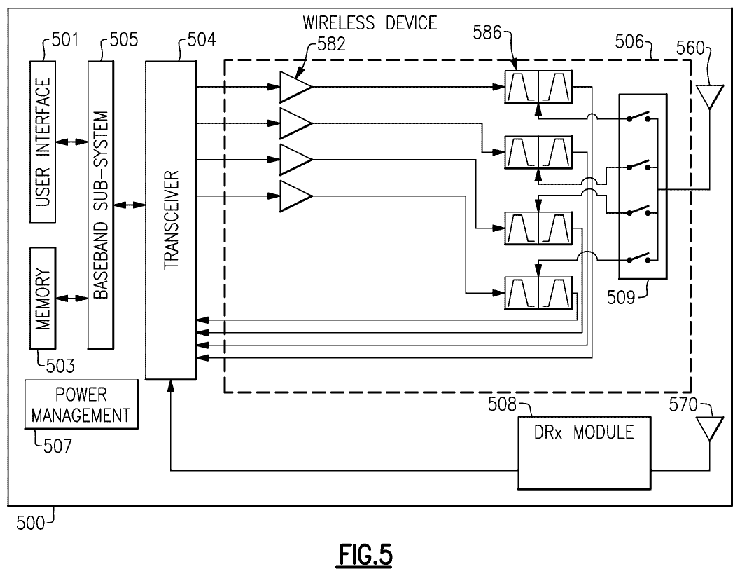

FIG. 5 depicts an example wireless device 500 having one or more advantageous features described herein. In the context of one or more modules having one or more features as described herein, such modules can be generally depicted by a dashed box 506 (which can be implemented as, for example, a front-end module) and a diversity receiver (DRx) module 508 (which can be implemented as, for example, a front-end module).

Referring to FIG. 5, power amplifiers (PAs) 582 can receive their respective RF signals from a transceiver 504 that can be configured and operated to generate RF signals to be amplified and transmitted, and to process received signals. The transceiver 504 is shown to interact with a baseband sub-system 505 that is configured to provide conversion between data and/or voice signals suitable for a user and RF signals suitable for the transceiver 504. The transceiver 504 can also be in communication with a power management component 507 that is configured to manage power for the operation of the wireless device 500. Such power management can also control operations of the baseband sub-system 505 and the modules 506 and 508.

The baseband sub-system 505 is shown to be connected to a user interface 501 to facilitate various input and output of voice and/or data provided to and received from the user. The baseband sub-system 505 can also be connected to a memory 503 that is configured to store data and/or instructions to facilitate the operation of the wireless device, and/or to provide storage of information for the user.

In the example wireless device 500, outputs of the PAs 582 are shown to be routed to their respective duplexers 586. The duplexers 586 can be configured as described herein to conglomerate TX contours to remove matching components between the PAs 582 and the duplexers 586. Such amplified and filtered signals can be routed to a primary antenna 560 through a switching network 509 for transmission. In some embodiments, the duplexers 586 can allow transmit and receive operations to be performed simultaneously using a common antenna (e.g., primary antenna 560). In FIG. 5, received signals are routed to low-noise amplifiers (not shown).

The wireless device also includes a diversity antenna 570 and a diversity receiver module 508 that receives signals from the diversity antenna 570. The diversity receiver module 508 processes the received signals and transmits the processed signals to the transceiver 504. In some embodiments, a diplexer, triplexer, or other multiplexer or filter assembly can be included between the diversity antenna 570 and the diversity receiver module 570, as described herein.

Transmission (TX) leakage in wireless communication devices can be defined as a portion of the signal energy that leaks through the transmitting components. More precisely, the TX leakage can be defined as in Equation 1:

TX leakage=G_{TX}+G_{RX}+FEMidₗₒₛₛ−Iso_{TX}+G_{LNA-mismatch-TX}=G_{PA}+G_{LNA}−Iso_{TX}+G_{LNA-mismatch-TX} [Equation 1]

In Equation 1, G_{TX} is the transconductance for transmission, G_{RX} is the transconductance for reception, FEMidₗₒₛₛ is the drain loss of the front-end module (FEM), Iso_{TX} is an amount of isolation, G_{LNA-mismatch-TX} is the transconductance generated due to LNA mismatch during transmission, G_{PA} is the transconductance of the power amplifier, and G_{LNA} is the transconductance of the low-noise amplifier.

The TX leakage in a front-end architecture is determined mostly by duplexer isolation. Conventionally, in order to optimize the TX leakage, focus is mainly directed on the design of certain duplexer isolation in the TX band. In other words, the value of transconductance generated due to LNA mismatch during transmission (G_{LNA-mismatch-TX}) is not taken into account.

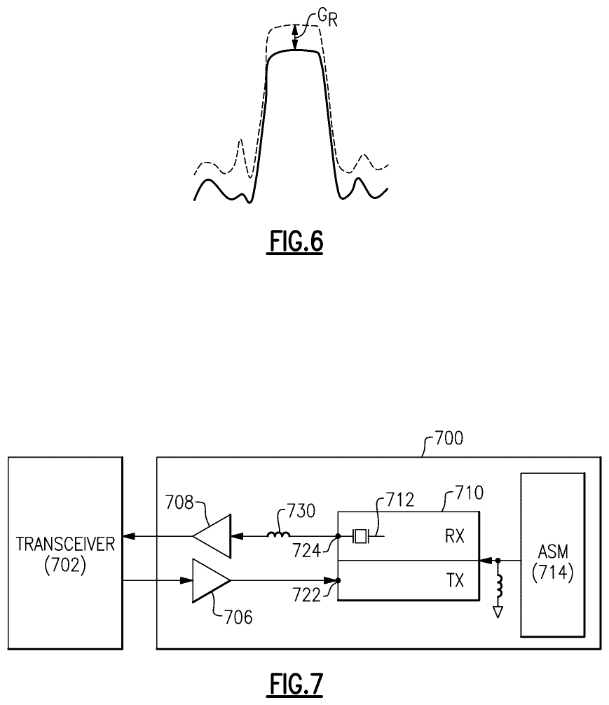

FIG. 6 illustrates a change of TX leakage when a mobile device is turned on. In FIG. 6, the straight line represents a transconductance of the mobile device when it is turned off depending on frequency. The dashed line represents a changed transconductance of the mobile device when it is turned on depending on frequency. The difference between the straight line and the dashed line in FIG. 6 corresponds to the transconductance generated due to LNA mismatch during transmission (G_{LNA-mismatch-TX}, hereinafter, referred to as “Gₘ”). As can be seen from FIG. 6, the lower the value of Gm is that can be obtained, the better the performance of the mobile device will be.

Most of the conventional approaches are merely taking into consideration the transconductance of the passive device (as indicated by the straight line). Thus, those approaches cannot meet the target requirement due to insufficiently failing to take all relevant factors into account.

In this disclosure, it is proposed to reduce the value of Gₘ, even to negative values, considering several factors that can significantly impact the performance of the mobile device. The factors taken into account to reduce the value of Gₘ may include at least the following: RX end resonator; T/R separation and location; LNA matching; and LNA impedance.

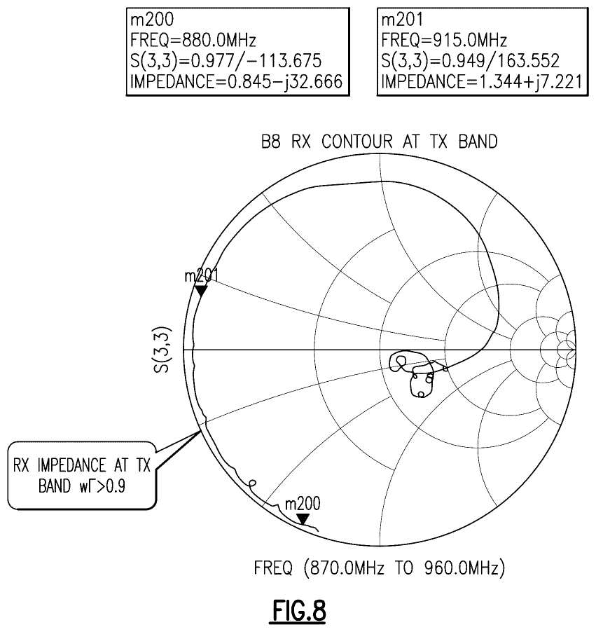

FIG. 7 illustrates a schematic diagram of an example of a radio frequency module 700 according to an embodiment of the present disclosure. The radio frequency module 700 may be a front-end module (FEM). The radio frequency module 700 may be a part of either of the mobile devices 100, 400, 500 shown in FIGS. 1, 4 and 5, respectively. As shown in FIG. 7, the radio frequency module 700 may be connected to a transceiver 702.

The radio frequency module 700 may include a power amplifier 706 configured to amplify the TX signal generated by the transceiver 702. The power amplifier 706 may be disposed along a TX signal path to amplify the TX signal for transmitting the TX signal. The radio frequency module 700 may include a low-noise amplifier (LNA) 708 configured to amplify the RX signal received from an antenna (not shown in FIG. 7). The radio frequency module 700 may further include a matching inductor 730 between the LNA 708 and the duplexer 710. The LNA 708 may be disposed along the RX signal path to amplify the RX signal for receiving the RX signal.

The radio frequency module 700 may include at least one duplexer 710 configured to filter the TX signal or the RX signal within respective frequency ranges. In FIG. 7, one duplexer 710 has been shown, but the number of duplexers is not limited thereto. The duplexer 710 may be coupled to the power amplifier 706 and the LNA 708 via a first node 722 and a second node 724, respectively. Thus, the duplexer 710 may provide a part of the TX signal path and also a part of the RX signal path in the duplexer 710. The duplexer 710 may include a series resonator 712 that is directly connected to the second node 724 along the RX signal path. The series resonator 712 may increase the capacitance of the RX impedance of the duplexer. Therefore, the impedance of the duplexer 710 along the RX signal path can be increased during the transmission of the TX signal. According to an embodiment of the present disclosure, a higher RX impedance value of the duplexer in the TX band may improve the TX leakage of the device.

In one example, the impedance of the duplexer 710 may be increased up to the coefficient Γ in a Smith Chart of higher than 0.9. Particularly, when the TX band for transmitting the TX signal is below a RX band for receiving RX signal, the benefits are stacking.

FIG. 8 illustrates an example of RX contours on a Smith Chart for an embodiment of the duplexer 710 configured for LTE FDD band B8 or for 5G band n8, having a transmit/uplink band of 880-915 MHz and a RX/downlink band of 925-960 MHz. As shown, the RX contour in FIG. 8 extends along the outer boundary of the Smith Chart where the higher coefficient is provided, and also comes down to the lower half of the Smith Chart, which yields higher capacitance values. For example, the RX impedance at the TX band may have a coefficient Γ greater than 0.9 across the TX band from 880 MHz (point m200) to 915 MHz (point m201).

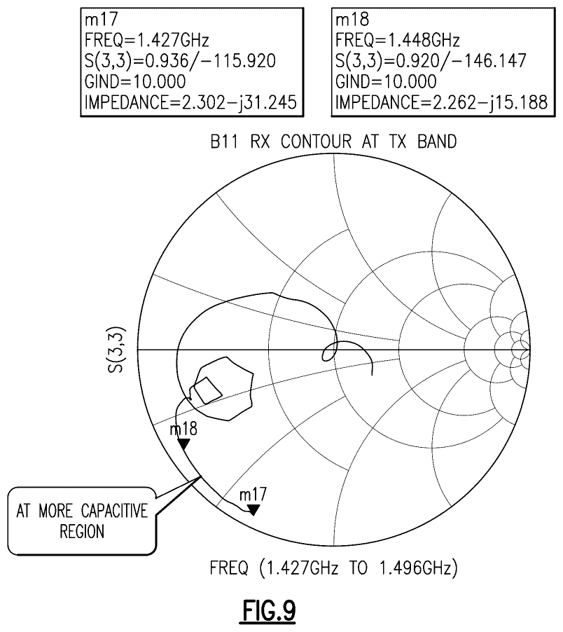

FIG. 9 illustrates another example of RX contours on a Smith Chart for an embodiment of the duplexer 710 configured for LTE FDD band B11, having a transmit/uplink band of 1.427-1.448 GHz and a RX/downlink band of 1.475-1.496 GHz. As shown, the RX contour in FIG. 9 moves toward the outer boundary of the Smith Chart and also comes down to the lower part of the Smith Chart. The RX impedance at the TX band may have a coefficient Γ greater than 0.9 across the TX band from 1.427 GHz (point m17) to 1.448 GHz (point m18).

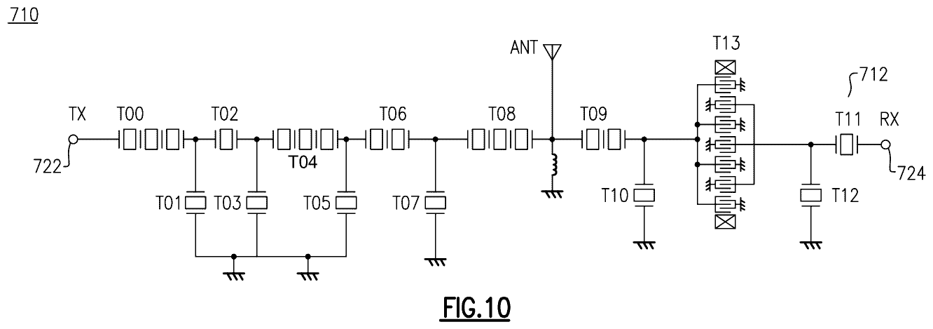

FIG. 10 illustrates an example of a duplexer 710 including a series resonator 712. As shown in FIG. 10, the duplexer 710 may include a node connected to an antenna, a TX end node, and an RX end node. The TX end node may correspond to the first node 722 in FIG. 7, and the RX end node may correspond to the second node 724 in FIG. 7.

The acoustic resonator elements T00-T12 can include one or more surface acoustic wave (SAW) resonators, one or more temperature compensated SAW (TCSAW) resonators, one or more multilayer piezoelectric substrate (MPS) SAW resonators, one or more bulk acoustic wave (BAW) resonators such as one or more film bulk acoustic wave resonators (FBARs) and/or one or more BAW solidly mounted resonators (SMRs), one or more Lamb wave resonators, one or more boundary wave resonators, the like, or any suitable combination thereof. The acoustic resonator elements T00-T12 can include one or more than one acoustic resonator. For example, in the illustrated embodiment, each of the acoustic resonator elements T00, T04, and T08 includes three acoustic resonators connected in series, the acoustic resonator element T09 includes two acoustic resonators connected in series, and the remaining elements include a single acoustic resonator each.

T13 can be a multi-mode surface acoustic wave (MMS) filter, which is a type of an acoustic wave filter including a plurality of interdigital transducer (IDT) electrodes longitudinally coupled to each other and positioned between acoustic reflectors. The MMS filter T13 can be a double mode surface acoustic wave (DMS) filter. There may be more than two modes of the DMS filters T13 (or other MMS filters). The MMS filter T13 can have a relatively wide passband due to a combination of various resonant modes. The MMS filter T13 can have a balanced (differential) input and/or a balanced output with proper arrangement of IDTs. The MMS filter T13 can have a single-ended input and/or a single-ended output in certain applications. The MMS filter T13 can achieve a relatively low loss and a relatively good out of band rejection.

In the illustrated embodiment, the acoustic resonator elements T00-T08 between the TX node and the antenna node are arranged in a ladder filter structure forming the TX filter portion of the duplexer 710. The acoustic resonator elements T09-T12 and the DMS filter T13 between the RX node 724 and the antenna node, on the other hand, can be arranged to form an RX filter portion of the duplexer 710.

As shown, the end series acoustic resonator 712 can be directly connected to the RX end node (second node 724). The end series resonator 712 can adjust the impedance of the RX portion of the duplexer 710. For example, the end series resonator 712 can adjust the RX impedance of the duplexer 710 at the TX band such that the coefficient Γ of the impedance across the TX band is larger than 0.9. The end series resonator 712 can adjust the RX impedance of the duplexer 710 at the TX band to be close to short for TX frequency above the RX frequency, and to be at a more capacitive region for RX frequency above the TX frequency. While the illustrated end series resonator 712 is a single resonator, in other embodiments, the end series acoustic resonator 712 can include multiple resonators, e.g., two, three or more resonators connected in series.

Although it is not shown in FIG. 10, the radio frequency module 700 may further include a matching inductor 730 disposed on the LNA side to lower a gain of the LNA 708 at a TX band, as illustrated in FIG. 7.

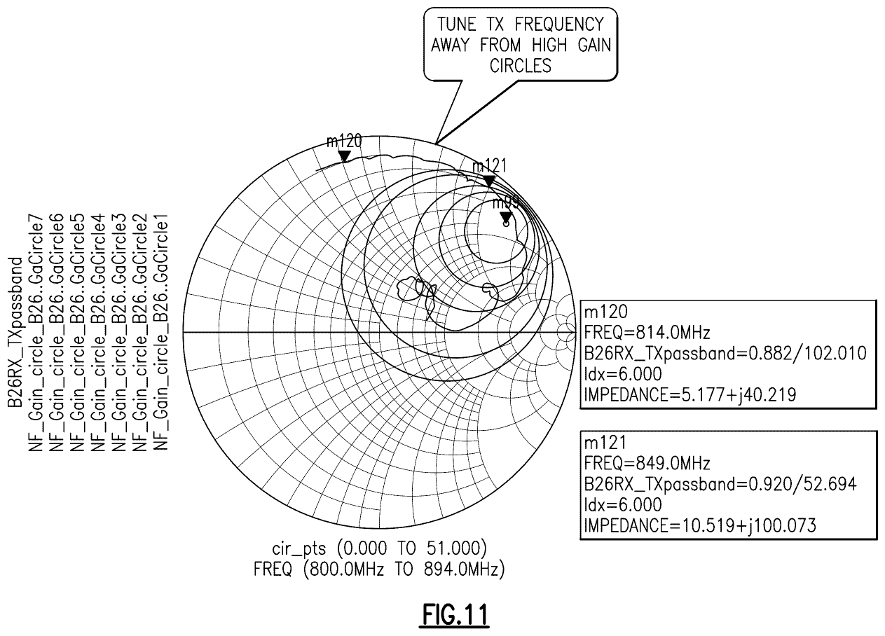

FIG. 11 illustrates an example of RX contour on Smith Chart for an embodiment of the radio frequency module 700 in which the duplexer 710 is configured for LTE FDD band B26 or for 5G band n26, having a transmit/uplink band of 814-849 MHz and a receive/downlink band of 859-894 MHz. In the Smith Chart, the amplitude gets larger in sequence from gain circle 7 (GaCircle 7) to gain circle 1 (GaCircle 1). Thus, the RX contour in FIG. 11 represents the growth of amplitude as the contour moves from the frequency point m121 (849 MHz) to the frequency point m120 (814 MHz), and then represents a decrease of the amplitude afterwards. In other words, the frequency point m121 exhibits higher LNA gain than the frequency point m120. According to an embodiment, avoiding high gains of RX impedance may lead to improved TX leakage for the transmission of signals.

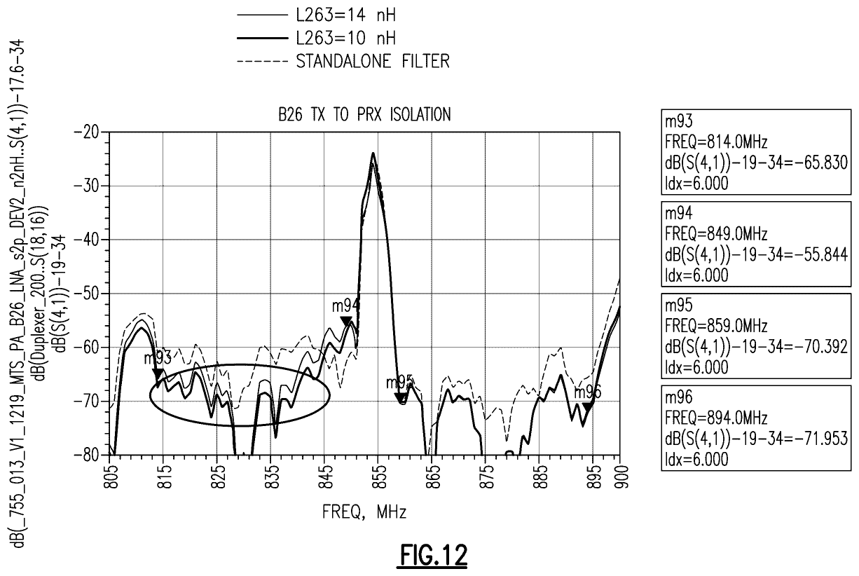

FIG. 12 illustrates an example of the frequency response of the duplexer 710 depending on the value of inductance of the matching inductor 730 (see FIG. 7), where the duplexer is configured for LTE FDD band B26. As shown in FIG. 12, the added matching inductor 730 gives improved TX to RX isolation of the duplexer 710. As indicated by the portions of the plots highlighted within the oval, a 10 nH matching inductor 730 provides better TX leakage suppression than a 14 nH matching inductor, and both 10 nH and 14 nH matching inductors 730 provide better TX leakage suppression than a duplexer that has no matching inductor 730.

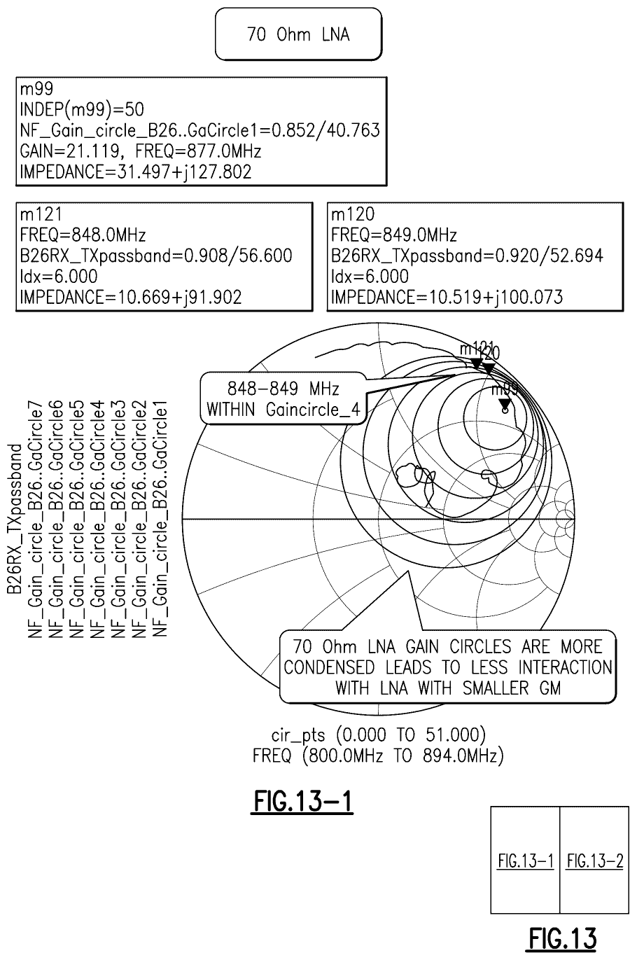

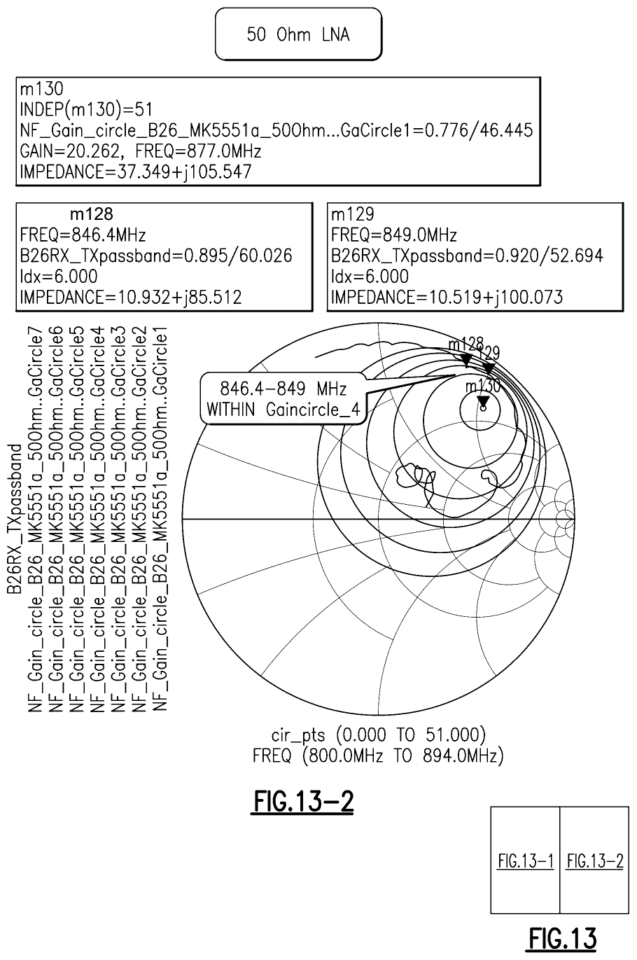

FIGS. 13-1 and 13-2 illustrate an example of the RX contour on a Smith Chart for duplexers 710 with LNAs 708 having different resistances (e.g., the real part of the impedance). As shown in FIG. 13-1, for an embodiment with an LNA 708 having an impedance of 70 Ohm, the gain circles are more condensed, leading to less interaction with the LNA 708 with lower values of Gₘ, as compared to an LNA having an impedance of 50 Ohms, which is represented in FIG. 13-2, and which has relatively less condensed LNA gain circles and more interaction with the LNA 708. For instance, as shown in FIG. 13-1, the RX contour for the embodiment with the 70 Ohm LNA is such that the RX impedance is within Gaincircle_4 for a relatively narrow frequency range of 848-849 MHz at the top end of the TX band, whereas the RX contour for the embodiment with the 50 Ohm LNA is such that the RX impedance is within Gaincircle_4 for a relatively wider frequency range of 846.4-849 MHz.

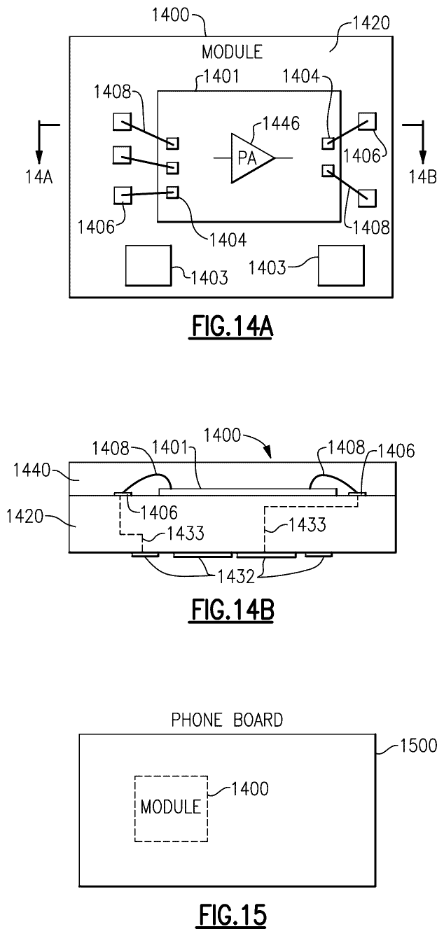

FIG. 14A is a schematic diagram of one embodiment of a packaged module 900. FIG. 14B is a schematic diagram of a cross-section of the packaged module 1400 of FIG. 14A taken along the lines 14A-14B.

The packaged module 1400 includes an IC or die 1401, surface mount components 1403, wirebonds 1408, a package substrate 1420, and encapsulation structure 1440. The package substrate 1420 includes pads 1406 formed from conductors disposed therein. Additionally, the die 1401 includes pads 1404, and the wirebonds 1408 have been used to electrically connect the pads 1404 of the die 1401 to the pads 1406 of the package substrate 1420.

The package module 1400 includes a low noise amplifier 1446, which can be implemented in accordance with any of the embodiments herein.

The packaging substrate 1420 can be configured to receive a plurality of components such as the die 1401 and the surface mount components 1403, which can include, for example, surface mount capacitors and/or inductors.

As shown in FIG. 14B, the packaged module 1400 is shown to include a plurality of contact pads 1432 disposed on the side of the packaged module 1400 opposite the side used to mount the die 1401. Configuring the packaged module 1400 in this manner can aid in connecting the packaged module 1400 to a circuit board such as a phone board of a wireless device. The example contact pads 1432 can be configured to provide RF signals, bias signals, power low voltage(s) and/or power high voltage(s) to the die 1401 and/or the surface mount components 1403. As shown in FIG. 14B, the electrically connections between the contact pads 1432 and the die 1401 can be facilitated by connections 1433 through the package substrate 1420. The connections 1433 can represent electrical paths formed through the package substrate 1420, such as connections associated with vias and conductors of a multilayer laminated package substrate.

In some embodiments, the packaged module 1400 can also include one or more packaging structures to, for example, provide protection and/or facilitate handling of the packaged module 1400. Such a packaging structure can include overmold or encapsulation structure 1440 formed over the packaging substrate 1420 and the components and die(s) disposed thereon.

It will be understood that although the packaged module 1400 is described in the context of electrical connections based on wirebonds, one or more features of the present disclosure can also be implemented in other packaging configurations, including, for example, flip-chip configurations.

FIG. 15 is a schematic diagram of one embodiment of a phone board 1500. The phone board 1500 includes the module 1400 shown in FIGS. 14A-14B attached thereto. Although not illustrated in FIG. 15 for clarity, the phone board 1500 can include additional components and structures.

### Applications

Some of the embodiments described above have provided examples in connection with wireless devices or mobile phones. However, the principles and advantages of the embodiments can be used for any other systems or apparatus that have needs for duplexers.

Such duplexers can be implemented in various electronic devices. Examples of the electronic devices can include, but are not limited to, consumer electronic products, parts of the consumer electronic products, electronic test equipment, etc. Examples of the electronic devices can also include, but are not limited to, memory chips, memory modules, circuits of optical networks or other communication networks, and disk driver circuits. The consumer electronic products can include, but are not limited to, a mobile phone, a telephone, a television, a computer monitor, a computer, a hand-held computer, a personal digital assistant (PDA), a microwave, a refrigerator, an automobile, a stereo system, a cassette recorder or player, a DVD player, a CD player, a VCR, an MP3 player, a radio, a camcorder, a camera, a digital camera, a portable memory chip, a washer, a dryer, a washer/dryer, a copier, a facsimile machine, a scanner, a multi-functional peripheral device, a wrist watch, a clock, etc. Further, the electronic devices can include unfinished products.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “can,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments.

While certain embodiments of the inventions have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

What is claimed is:

1. A radio frequency module comprising:
a transmit amplifier configured to amplify a transmit signal;
a receive amplifier configured to amplify a receive signal; and
at least one duplexer configured for operation in a frequency division duplex band having a transmit band and a receive band and further configured to filter the transmit signal to pass the transmit band and to filter the receive signal to pass the receive band, the at least one duplexer coupled to the transmit amplifier via a first node and to the receive amplifier via a second node, the at least one duplexer including a series acoustic resonator directly connected to the second node to increase a receive impedance of the at least one duplexer across the transmit band of the at least one duplexer.

2. The radio frequency module of claim 1 wherein the radio frequency module is a front-end module.

3. The radio frequency module of claim 1 wherein a coefficient Γ of the receive impedance is larger than 0.9 across the transmit band.

4. The radio frequency module of claim 1 wherein the transmit band is below the receive band.

5. The radio frequency module of claim 1 further comprising a matching inductor disposed between the receive amplifier and the at least one duplexer to lower a gain of the receive amplifier at the transmit band.

6. The radio frequency module of claim 1 wherein the frequency division duplex band is an LTE or 5G band.

7. The radio frequency module of claim 1 wherein the frequency division duplex band is B8, B11, or B26.

8. A mobile device comprising:
a transceiver; and
a radio frequency module including transmit amplifier configured to amplify a transmit signal, a receive amplifier configured to amplify a receive signal, and at least one duplexer configured for operation in a frequency division duplex band having a transmit band and a receive band and further configured to filter the transmit signal to pass the transmit band and to filter the receive signal to pass the receive band, the at least one duplexer coupled to the transmit amplifier via a first node and to the receive amplifier via a second node, the at least one duplexer including a series acoustic resonator directly connected to the second node to increase a receive impedance of the at least one duplexer across the transmit band of the at least one duplexer.

9. The mobile device of claim 8 wherein the radio frequency module is a front-end module.

10. The mobile device of claim 8 wherein a coefficient Γ of the receive impedance is larger than 0.9 across the transmit band.

11. The mobile device of claim 8 wherein the transmit band is below the receive band.

12. The mobile device of claim 8 further comprising a matching inductor disposed between the receive amplifier and the at least one duplexer to lower a gain of the receive amplifier at the transmit band.

13. The mobile device of claim 8 wherein the frequency division duplex band is an LTE or 5G band.

14. The mobile device of claim 8 wherein the frequency division duplex band is B8, B11, or B26.

15. An antenna switch module arrangement comprising:
an antenna switch module including at least two transmit/receive terminals and an antenna terminal; and
at least two duplexers, each respective duplexer of the at least two duplexers coupled to a corresponding one of the at least two transmit/receive terminals, and each configured for operation in a frequency division duplex band having a transmit band and a receive band, and further configured to filter a transmit signal to pass the transmit band and to filter a receive signal to pass the receive band, the respective duplexer configured for coupling to a transmit amplifier via a first node and for coupling to a receive amplifier via a second node, the respective duplexer including a series acoustic resonator directly connected to the second node to increase a receive impedance of the respective duplexer across the transmit band of the respective duplexer.

16. The antenna switch module arrangement of claim 15 wherein, for each respective duplexer of the at least two duplexers, a coefficient Γ of the receive impedance is larger than 0.9 across the transmit band.

17. The antenna switch module arrangement of claim 15 wherein, for each respective duplexer of the at least two duplexers, the transmit band is below the receive band.

18. The antenna switch module arrangement of claim 15 further comprising, for each respective duplexer of the at least two duplexers, a matching inductor disposed between the receive amplifier and the respective duplexer to lower a gain of the receive amplifier at the transmit band.

19. The antenna switch module arrangement of claim 15 wherein frequency division duplex band of each respective duplexer is an LTE or 5G band.

20. The antenna switch module arrangement of claim 19 wherein frequency division duplex band of each respective duplexer is LTE band B8, B11, or B26.
